(19) United States
(12) Patent Application Publication
(10) Pub. No.: US 2026/0278382 A1
(43) Pub. Date: Sep. 17, 2026

(54) SYSTEM AND METHOD OF FINE-TUNING LARGE LANGUAGE MODELS USING DIFFERENTIAL PRIVACY

(71) Applicants: University of South Florida, Tampa, FL (US); Arizona Board of Regents on Behalf of the University of Arizona, Tucson, AZ (US)

(72) Inventors: Mohammadreza Ebrahimi, Tampa, FL (US); Rouzbeth Behnia, Tampa, FL (US); Balaji Padmanabhan, Tampa, FL (US); Jason Pacheco, Tucson, AZ (US)

(21) Appl. No.: 19/081,509

(22) Filed: Mar. 17, 2025

(51) Int. Cl. G06N 3/084; G06F 21/62; G06N 3/0475

(52) U.S. Cl. CPC G06N 3/084; G06F 21/6218; G06N 3/0475

(57) ABSTRACT

A system and method of fine-tuning a large language model including differential privacy includes pretraining a large language model using a non-private dataset to generate a pretrained output. The pretrained output is used as an input to a fine-tuning model. The pretrained output is fine-tuned using a private dataset to generate a differentially private large language model. A set of privacy parameters including a privacy budget and a failure probability are determined. A privacy analysis agent calculates a desired amount of privacy based on the privacy budget, and calculates a noise multiplier based on the desired amount of privacy. The pretrained model is transformed using the noise multiplier to add an amount of noise to the pretrained output. A randomized differentially private stochastic gradient descent model fine-tunes the transformed pretrained output by reparametrizing a weight matrix associated with each layer of the transformed pretrained output.

### CROSS REFERENCE TO RELATED APPLICATIONS

This nonprovisional application is a continuation of and claims priority to PCT International Patent Application No. PCT/US2023/033032, entitled “SYSTEM AND METHOD OF FINE-TUNING LARGE LANGUAGE MODELS USING DIFFERENTIAL PRIVACY,” filed Sep. 18, 2023, to the same inventors, which is a nonprovisional of and claims priority to U.S. Provisional Patent Application No. 63/375,862, entitled “EW-Tune: A Framework for Privately Fine-Tuning Large Language Models with Differential Privacy,” filed on Sep. 16, 2022, to the same inventors, the entirety of which are incorporated herein by reference.

### BACKGROUND OF THE INVENTION

### 1. Field of the Invention

This invention relates, generally, to enhancing privacy of a large language model. More specifically, it relates a system and method of fine-tuning large language models using differential privacy to introduce noise into a large language model while maintaining performance.

### 2. Brief Description of the Prior Art

Large language models (LLMs) have become integral components of modern artificial intelligence (AI) models, providing breakthrough performance in complex AI tasks, including dialogue systems [2] and text/automated story generation [3]. Deep learning architectures with billions of parameters are often designed based on transformers, which were first introduced by the BERT model [1]. LLMs are deep neural network architectures with billions of parameters [16-18], which often benefit from an encoder-decoder architecture that generates high-quality representations from sequence data (such as text, image, malware, and genes). Most LLMs use specific types of layers with transformers, which are self-attention mechanisms used to dynamically assign weights to input elements based on surrounding context [16].

Transformers enable LLMs to provide high-quality representations of the input sequence, and can be categorized as either masked models or autoregressive models. Masked language models are trained to predict a masked token based on its surroundings. For example, current major masked AI implementations are trained on public data from the internet (such as online news articles), including BERT [1] and RoBERTa [16]. In addition, current autoregressive models (including GPT models trained on outbound links on internet forums [5]) learn to predict the next token based on previously generated tokens, making them suitable for text generation tasks [4, 19]. Due to their ability to produce high-quality representations from inputs, masked language models are widely used in major downstream AI tasks, including text classification, question answering, semantic entailment detection, and speech recognition.

Pre-trained models such as those described above often require fine-tuning for downstream AI tasks. Typically, such fine-tuning includes the use of private data to accomplish downstream tasks, including malware detection [6], text-to-image generation [7]. However, such pre-trained models are vulnerable to privacy attacks [8], mainly due to the tendency to memorize training samples without overfitting the data, which is also referred to as a “memorization issue” for such models [9]. These issues lead to three major types of privacy attacks: membership inference [10](which determines whether a certain user's data was included in the training set); model inversion [11](which approximates the reconstruction of the training data); and training data extraction [8](which aims to exactly reveal the training samples).

The training data extraction is the most powerful type of attack with the most adverse consequences for the users, since they can jeopardize the privacy of the users whose information is in the training data, endangering user identities by revealing information including addresses, social security numbers, phone numbers, and other confidential information. The fine-tuned LLMs used by third parties on private data face the same privacy concerns, which necessitate privacy-preserving approaches without information leaks regarding private training samples.

Differential privacy (DP) is a promising approach to ensure training data privacy with theoretical guarantees [12] by providing a mathematically rigorous framework with privacy guarantees that enable stochastic gradient descent (SGD), which the cornerstone of learning in LLMs, in a private setting. In such private settings, SGD can be applied as a randomized mechanism multiple times in each iteration of the training. Most DP method provide asymptomatic guarantees; however, for theoretical guarantees, the number of SGD applications (known as compositions) is often assumed to be unlimited in most privacy studies, leading to asymptotic guarantees (i.e., infinite compositions of SGD in the limit). In LLM fine-tuning, the number of SGD iterations is not only limited, but also very small, typically in the order of several thousand [13].

While attempts have been made to introduce DP protocols into language models, the results enhance model privacy at the expense of utility and performance. For example, one study introduced a method called Moments Accountant (MA) (a privacy analysis agent, also referred to as an account that, that determines an amount of privacy based on a privacy budget) for computing an upper bound for the privacy curve of compositions of DP algorithms. The method was then used to track the privacy loss of differentially private stochastic gradient descent (DP-SGD) approaches by computing the privacy curve for each training iteration with itself for m iterations [12]. In another approach, the MA framework was instantiated with Renyi Differential Privacy (RDP) [21]. However, while each approach provides efficient runtimes that are independent of m, the upper bound of each approach is impractical in implementation. Another approach included a Gaussian Differential Privacy (GDP) framework, also referred to as f-DP, that was devised based on the central limit theorem (CLT). The GDP framework offers a good characterization of DP using hypothesis testing interpretation, but can only provide an approximation for the privacy curve. In addition, such approaches were shown to underreport the true epsilon value [22-25].

In addition, attempts have been made to use privacy loss random variables (PRV) to approximately compose privacy curves via an agent called privacy bucket [26, 27]. As such, PRV can be used to compute the composition of m mechanisms M=M₁ ∘M₂ ∘ . . . ∘Mₘ by summing their corresponding PRV's

$$𝒟 = {\sum }_{i = 1}^{m} {𝒟}_{i} .$$

The distribution of [symbol] can then be approximated by computing the convolution of its underlying distributions [symbol] ₁, . . . , [symbol] ₘ. In addition, attempts have been made to use fast Fourier transforms (FFT) to compute the convolution efficiently [28], and other attempts have levered FFT to numerically compose tradeoff functions [25]. Their privacy analysis agent, referred to as the PRV accountant, addresses the underestimation of f-DP and provides an upper bound and lower bound on the leakage of the privacy budget E.

Accordingly, what is needed is a system and method of fine-tuning large language models using differential privacy to introduce noise into a large language model while maintaining performance. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for a system and method of fine-tuning a large language model including differential privacy is now met by a new, useful, and nonobvious invention.

The novel method of fine-tuning a large language model includes a step of pretraining a large language model using a non-private dataset to generate a pretrained output. The pretrained output is used as an input to a fine-tuning model. The method includes a step of fine-tuning the pretrained output using a private dataset to generate a differentially private large language model. The fine-tuning step includes a step of determining a set of privacy parameters including a privacy budget and a failure probability. In an embodiment, the privacy budget and the failure probability are predetermined inputs into the differentially private large language model. A privacy analysis agent calculates a desired amount of privacy based on the privacy budget, and calculates a noise multiplier based on the desired amount of privacy to satisfy the privacy budget. The pretrained model is transformed using the noise multiplier to add an amount of noise to the pretrained output by clipping gradients of the pretrained output, aggregating the clipped gradients, and adding the amount of noise to the clipped gradients.

The method includes a step of fine-tuning, via a randomized differentially private stochastic gradient descent model, the transformed pretrained output by reparametrizing a weight matrix associated with each layer of the transformed pretrained output. In an embodiment, the randomized differentially private stochastic gradient descent model is derived from a reparametrized gradient perturbation. An embodiment of the method includes a step of fine-tuning, using the private dataset, each of a plurality of transformer layers of the transformed pretrained output.

In an embodiment, the method includes a step of defining, via the privacy analysis agent, a plurality random privacy-loss log-likelihood ratios. An embodiment of the method includes a step of approximating, via the privacy analysis agent and for each of the plurality of random privacy-loss log-likelihood ratios, a cumulative distribution function. In an embodiment, the method includes a step of calculating a plurality of privacy budget guarantees based on the plurality of random privacy-loss log-likelihood ratios.

An embodiment of the method includes a step of computing, via the privacy analysis agent, a number of applications of the randomized differentially private stochastic gradient descent model to satisfy the privacy budget.

The novel differentially private system including a fine-tuned large language model includes a processor and a non-transitory computer-readable medium operably coupled to the processor. The computer-readable medium has computer-readable instructions stored thereon that, when executed by the processor, cause the differentially private system to fine-tune the large language model by executing certain instructions. The instructions include pretraining a large language model using a non-private dataset to generate a pretrained output; inputting the pretrained output into a fine-tuning model; and fine-tuning the pretrained output using a private dataset to generate a differentially private large language model.

The instructions of fine-tuning the pretrained output include determining a set of privacy parameters including a privacy budget and a failure probability. In an embodiment, the privacy budget and the failure probability are predetermined inputs into the differentially private large language model. In addition, the instructions include calculating, via a privacy analysis agent, a desired amount of privacy based on the privacy budget, and calculating, via the privacy analysis agent, a noise multiplier based on the desired amount of privacy to satisfy the privacy budget. The instructions include transforming the pretrained output using the noise multiplier to add an amount of noise to the pretrained output by clipping gradients of the pretrained output, aggregating the clipped gradients, and adding the amount of noise to the clipped gradients.

The instructions include fine-tuning, via a randomized differentially private stochastic gradient descent model, the transformed pretrained output by reparametrizing a weight matrix associated with each layer of the transformed pretrained output. In an embodiment, the randomized differentially private stochastic gradient descent model is derived from a reparametrized gradient perturbation. An embodiment of the instructions includes fine-tuning, using the private dataset, each of a plurality of transformer layers of the transformed pretrained output.

In an embodiment, the instructions include defining, via the privacy analysis agent, a plurality random privacy-loss log-likelihood ratios. An embodiment of the instructions includes approximating, via the privacy analysis agent and for each of the plurality of random privacy-loss log-likelihood ratios, a cumulative distribution function. In an embodiment, the instructions include calculating a plurality of privacy budget guarantees based on the plurality of random privacy-loss log-likelihood ratios.

An embodiment of the instructions includes computing, via the privacy analysis agent, a number of applications of the randomized differentially private stochastic gradient descent model to satisfy the privacy budget.

An object of the invention is to improve the privacy and reduce the identification of datasets used to train large language models, such as by introducing noise into the models, while maintaining high performance of the models.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 schematically depicts a framework of a system and method of fine-tuning a large language model using differential privacy to introduce noise into a large language model while maintaining performance, in accordance with an embodiment of the present invention.

FIG. 2 depicts an embodiment of the system and method of fine-tuning a large language model using differential privacy of FIG. 1.

FIG. 3 graphically depicts a comparison between the system and method of fine-tuning a large language model and an alternative differential privacy system, particularly depicting changes of the privacy budget E with the number of stochastic gradient descent invocations for 8=0.001 (on the left side of the graph) and for 6=0.005 (on the right side of the graph), in accordance with an embodiment of the present invention.

FIG. 4 graphically depicts a comparison between the system and method of fine-tuning a large language model and an alternative differential privacy system, particularly depicting the effect of noise multiplier values on the privacy budget E for different values of training rounds m, in accordance with an embodiment of the present invention.

FIG. 5 graphically depicts a comparison between the system and method of fine-tuning a large language model and an alternative differential privacy system, particularly depicting the sensitivity of the privacy budget E to the batch size for different text datasets (including MNLI, QNLI, QQP, and SST-2 datasets), in accordance with an embodiment of the present invention.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise. All numerical designations, including ranges, are approximations which are varied up or down by increments of 1.0 or 0.1, as appropriate. It is to be understood, even if it is not always explicitly stated that all numerical designations are preceded by the term “about.” As used herein, “about,” “approximately,” or “substantially” refer to being within an acceptable error range for the particular value as determined by one of ordinary skill in the art, which will depend in part on how the value is measured or determined. As used herein, the terms “about,” “approximately,” and “substantially” refer to ±10% of the numerical; it should be understood that a numerical including an associated range with a lower boundary of greater than zero must be a non-zero numerical, and the terms “about,” “approximately,” and “substantially” should be understood to include only non-zero values in such scenarios.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments.

The present invention includes a system and method of fine-tuning a large language model including differential privacy that includes pretraining a large language model using a non-private dataset to generate a pretrained output. The pretrained output is used as an input to a fine-tuning model. The pretrained output is fine-tuned using a private dataset to generate a differentially private large language model. Specifically, a set of privacy parameters are determined, with the privacy parameters including a privacy budget and a failure probability. A privacy analysis agent calculates a desired amount of privacy based on the privacy budget, and calculates a noise multiplier based on the desired amount of privacy to satisfy the privacy budget. The pretrained model is transformed using the noise multiplier to add an amount of noise to the pretrained output by clipping gradients of the pretrained output, aggregating the clipped gradients, and adding the amount of noise to the clipped gradients. A randomized differentially private stochastic gradient descent model fine-tunes the transformed pretrained output by reparametrizing a weight matrix associated with each layer of the transformed pretrained output. The system and method of fine-tuning a large language model including differential privacy will be described in greater detail in the sections herein below.

Differential privacy computes a privacy guarantee when the results of a model running on private data are made public. When applied to machine learning, a differentially private (DP) mechanism allows for the public release of model parameters while ensuring the privacy of the original training data. DP is defined as follows: a randomized mechanism M: [symbol] → [symbol] is (∈,δ)-DP, if for all adjacent datasets X, X′∈ [symbol] , differing in a single element only, and all Y⊂ [symbol] , [symbol] (M(X)∈Y)≤e^{∈} [symbol] (M(X′)∈Y)+δ holds. The privacy budget, (∈,δ), includes ∈, which defines the distance between the two sides of the equation, and δ, which defines a failure probability. Differential privacy results in properties including robustness to auxiliary information (which guarantees privacy even with the emergence of new side-information to the adversary) and composability (which allows for modular design of mechanisms). For example, if two mechanisms M₁(⋅) and M₂(⋅) are DP, and M(X)=(M₁(X),M₂(X)), then M is also differentially private.

In an embodiment, differential privacy is achieved in a deep learning model by updating the neural network parameters with noisy gradients, such as by using a randomized differentially private stochastic gradient descent (DP-SGD) algorithm. In an embodiment of a DP-SGD algorithm, a first step includes gradient clipping, and a second step includes an application of a Gaussian mechanism to the clipped gradients. Specifically, given a clipping norm C, the gradient of each sample x, g′(x) is clipped in accordance with the following:

$${g}^{′} ( x ) ← g ( x ) / max ( 1 , \frac{{‖ g ( x ) ‖}^{2}}{C} ) .$$

The clipped gradients are then aggregated and an isotropic Gaussian noise from [symbol] (0,C²σ²), with a as a noise multiplier, is added to the gradients. The noise multiplier is determined by the privacy budget (∈,δ), the number of training rounds m, and the sampling probability q=B/N for batch size B and the number of samples N.

Given a DP system, a privacy analysis agent (also referred to as an accountant) determines an amount of privacy based on a privacy budget. In an embodiment of the system, an accountant relies on f-DP to provide a full characterization of differential privacy by utilizing hypothesis testing interpretation. Differential privacy measures the difficulty in distinguishing any pair of datasets, such as neighboring datasets, based on the information obtained from a mechanism M. In an embodiment, hypotheses are formed as H₀ (underlying dataset of S) and H₁ (underlying dataset of S′), where the output of M is the basis for conducting a hypothesis testing problem. The probability distribution of M(S) is denoted as P, and the probability distribution of M(S′) is denoted as Q. For a rejection rule 0≤Ø≤1 and hypotheses H₀:P and H₁:Q, the tradeoff function ƒ=T(P,Q)(α)=inf{β_{Ø}:α_{Ø}≤α} defines the mapping from the Type-I error to the Type-II error, where α_{Ø}= [symbol] _{Q}[Ø]. To compute the composition of the tradeoff functions of the form

$$f = {⊗}_{i = 1}^{m} {f}_{i} ,$$

the i-th composition is realized by two hypotheses: H_{0,i}=wᵢ~Pᵢ and H_{1,i}=wᵢ~Qᵢ. Two composite hypotheses are used to distinguish and evaluate the tradeoff function

$$f = {⊗}_{i = 1}^{m} {f}_{i} ,$$

namely, H_{0,i}=w~P₁×P₂× . . . ×Pₘ and H_{1,i}=w~Q₁×Q₂× . . . ×Qₘ for w=(w₁, . . . , wₘ).

The privacy analysis agent defines random variables (privacy-loss log-likelihood ratios, or PLLRs) to enable the lossless conversion of the ƒ-DP guarantee into a collection of (∈,δ)-DP guarantees. PLLRs are defined as Radon-Nikodym derivatives of the above hypotheses as

$${X}_{i} ≡ log \frac{{dQ}_{i} ( {ζ}_{i} )}{{dP}_{i} ( {ζ}_{i} )} and {Y}_{i} ≡ log \frac{{dQ}_{i} ( {χ}_{i} )}{{dP}_{i} ( {χ}_{i} )} for ζ ∼ {P}_{i} and χ ∼ {Q}_{i} .$$

There is a primal-dual relationship between ƒ-DP and a collection of (∈,δ(∈))-DP via δ=1−F_{Y,m}(∈)−e^{∈}(1−F_{X,m}(∈)), where F_{X,m} is the cumulative distribution function (CDF) of

$${\sum }_{i = 1}^{m} {X}_{i}$$

and where F_{Y,m} is the CDF of

$${\sum }_{i = 1}^{m} {Y}_{i} .$$

To complete PLLRs through composite hypotheses, the privacy analysis agent uses a family of PLLR sequences to compose the tightest possible tradeoff function that satisfies all ƒ^{(α)}-DP.

Assuming that for each α, a series of PLLRs corresponding to ƒ^{(α)} are found, and a collection of (∈,δ^{α}(∈))-DP guarantees are computed. Next, an approximate CDF is computed as a random variable

$$X = {\sum }_{i = 1}^{m} {X}_{i}$$

using expansion of the privacy analysis agent to output the agent approximations as F_{X,m} and F_{Y,m}.

Turning to the vulnerabilities of large language models, in some embodiments, an adversary A gains black-box access to the LLM but does not have access to the model's specific weights and hidden states. However, the adversary A is capable of obtaining next-work predictions and computing the probabilities of arbitrary sequences, such as via access to auto-complete models. The goal of the adversary A is to extract the memorized training data from the model; the severity of an attack increases if more examples are extracted from the model.

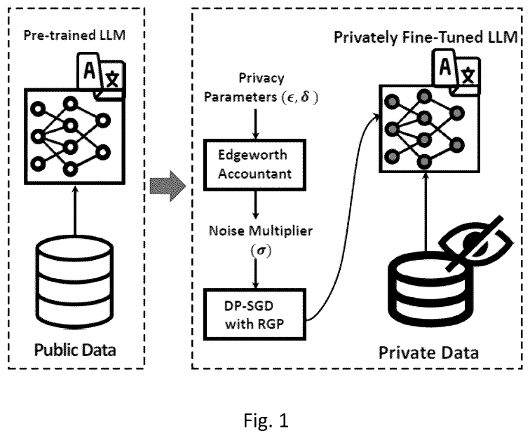

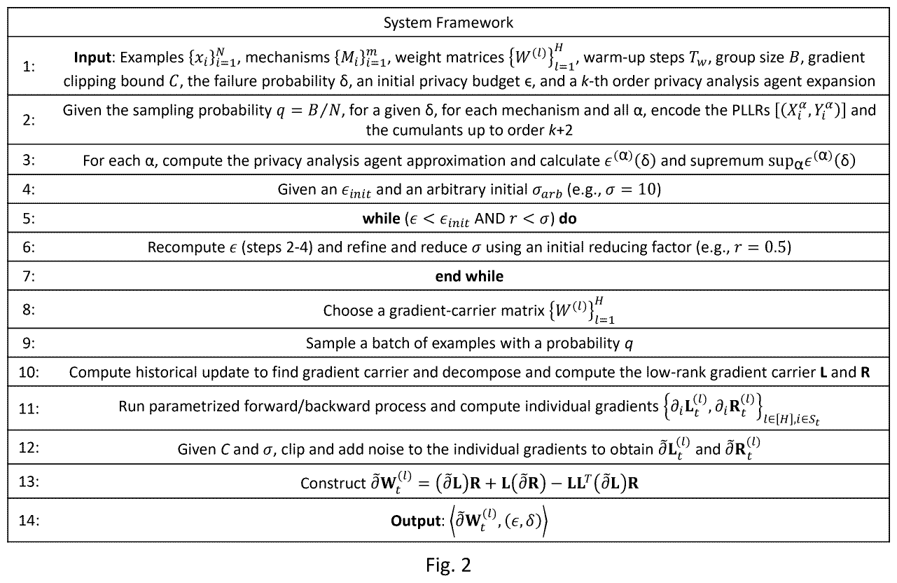

Accordingly, and as shown in FIGS. 1-2, the system and method of fine-tuning large language models uses differential privacy to introduce noise into a large language model while maintaining performance. In an embodiment, the pre-trained LLM is trained on a public dataset (such as from the internet) from scratch by a pre-existing AI model (shown on the left side of FIG. 1). Subsequently, the pre-trained model is used as an input to the system and method for fine-tuning using privacy guarantees expressed by privacy parameters (i.e., privacy budget ∈∈[0, ∞] and failure probability δ∈[0,1]), as shown on the right side of FIG. 1; in an embodiment, the privacy parameters (∈,δ) are predetermined inputs into the system and method. A smaller value associated with ∈ indicates better privacy preservation (and in some embodiments, lower utility and/or performance). In addition, the value associated with δ denotes the probability that the training examples are accidentally discoverable.

After receiving the privacy parameters, in an embodiment of the system and method, the privacy analysis agent computes the number of compositions (i.e., applications of DP-SGD) for a given dataset, as well as the amount of noise (i.e., the noise multiplier a) that guarantees the received privacy budget. Subsequently, one or more variations of DP-SGD are used to fine-tune the LLM on a private dataset based on the appropriate noise multiplier a. In an embodiment, the system and method use a DP-SGD derived from a reparametrized gradient perturbation (RGP) that reparametrizes each layer's weight matrix W into two low rank gradient-carrier matrices L and R, as well as a residual weight matrix \tilde{W}. Finally, all transformer layers of the LLM are fine-tuned on the private data through DP-SGD. The output of the system and method is the fine-tuned LLM as shown on the right side of FIG. 1.

The system and method are shown in greater detail in FIG. 2. Specifically, in an embodiment, the system and method include the computation of a privacy budget ∈ for a given failure probability δ based on the privacy analysis agent by first computing the PLLRs, and subsequently approximating their CDF using a privacy analysis agent expansion. Next, the system and method calculate ∈^{(α)}(δ) and its supremum. Subsequently, the final ∈ and an appropriate noise multiplier a are calculated for use in a reparametrized gradient perturbation. Specifically, with each iteration of the loop, σ=σ−r and the initial tuning factor r is reduced by a predetermined, constant factor (for example, in an embodiment, the initial tuning factor is reduced by r/10). Then, given the σ, the system and method perturbs the updated parameters via the reparametrized gradient perturbation system. Specifically, for each update with the weight matrix W, the system generates the gradient carrier matrices L and R via a decomposition method, thereby generating an output of an orthonormalized version (such as via Gram-Schmidt orthonormalization process) of the gradient carrier matrices. Next, the gradients are clipped and noise in introduced, such as via a DP-SGD method as previously discussed. Finally, the noisy aggregated gradients of the carrier matrices

$$〈 \tilde{\partial } {W}_{t}^{( l )}$$

are used to compute the gradients of the original weights.

The noise estimator relies on the ƒ-DP, which uses the hypothesis testing interpretation to offer a full characterization of DP. Intuitively, DP measures the indistinguishability between two estimated output probability distributions M(D) and M(D′), where mechanism M is the application of SGD. The two hypotheses are formed based on the output of the SGD algorithm where H₀ states the underlying dataset is D and where H₁ states the underlying hypothesis is D′. For P as the probability distribution of M(D) and for Q as the probability distribution of M(D′), the noise estimator defines a tradeoff function T[0,1]ß[0,1] with rejection rule Phi for testing H₀ against H₁. Specifically, T(P,Q)(α)=inf_{φ}{1− [symbol] _{Q}(φ): [symbol] _{P}(φ)≤α}. For the Type-I error [symbol] _{P}(φ) and the Type-II error 1− [symbol] _{Q}(φ), T implies the minimum Type-II error that can be attained given the significance level α. A larger tradeoff function implies a harder hypothesis testing problem, which corresponds to a higher level of privacy. For two identical distributions, the tradeoff function is T(P,P)(α)=1−α, which implies perfect privacy and requires no noise to be added.

To evaluate the tradeoff function, the system and method distinguish between two composite hypotheses H_{(0,i)}=output P₁×P₂× . . . ×Pₙ and H_{(1,i)}=output Q₁×Q₂××Qₙ by first computing the privacy log-like ratios (ref sharp composition) with respect to H_{(0,i)} and H_{(1,i)} as

$${X}_{i} ≡ log \frac{{dQ}_{i} ( {x}_{i} )}{{dP}_{i} ( {x}_{i} )} and {Y}_{i} ≡ log \frac{{dQ}_{i} ( {y}_{i} )}{{dP}_{i} ( {y}_{i} )} ,$$

where xᵢ~Pᵢ and yᵢ~Qᵢ.

Rather than utilizing the Central Limit Theorem (CLT) to analyze the privacy bounds under compositions, since during fine-tuning the number of compositions is often small (in orders of thousands) and CLT-obtained bounds are inaccurate, the system and method utilize a privacy analysis agent expansion to obtain explicit finite-sample bounds on privacy log-like ratios to derive an accurate characterization of (▮,δ)-DP (which differs from the method used in [32] which utilized an expansion to obtain better estimation/refinement on the CLT to approximate the ƒ-DP curve).

To calculate an approximation using the privacy analysis agent expansion on the CDF of Xᵢs (with the same derivations applying to Yᵢs), the standardized sum,

$${S}_{n , x} = \frac{X - {M}_{n}}{{Γ}_{n}} where X = {\sum }_{i = 1}^{n} {X}_{i} , {M}_{n}^{X} = {\sum }_{i = 1}^{n} 𝔼 [ {X}_{i} ] , and {Γ}_{n}^{X} = \sqrt{{\sum }_{i = 1}^{n} 𝔼 [ {( {X}_{i} - 𝔼 [ {X}_{i} ] )}^{2} ]} ,$$

is calculated as the standard deviation of the sum of the Xᵢs. In an embodiment, the average individual standard deviation

$$\overline{{Γ}_{n}^{X}} = \frac{{Γ}_{n}^{X}}{\sqrt{n}}$$

and average standardized kth raw moment

$${λ}_{K , n} = 1 / n {\sum }_{i = 1}^{n} 𝔼 [ {X}_{i}^{k} ] / \overline{{Γ}_{n}^{X}}$$

to compute the first order expansion as E_{n,1,X}(x)=Φ(x)+λ_{3,n}(6\sqrt{n})⁻¹(1−x²)φ(h), denoting Φ as the cumulative distribution function of a standard Gaussian random variable, and φ as its density function. As such, X and Y are estimated using first order privacy analysis agent approximation as

$${G}_{n , 1 , X} ( x ) = {E}_{n , 1 , X} ( ( x - {M}_{n}^{X} ) {Γ}_{n}^{X} ) and {G}_{n , 1 , Y} ( x ) = {E}_{n , 1 , Y} ( ( x - {M}_{n}^{Y} ) {Γ}_{n}^{Y} ) ,$$

where G_{n,1,X}(x) denotes the estimation of X and G_{n,1,Y}(x) denotes the estimation of Y under first-order expansion with n compositions. To bound the approximation, given the independent and identically distributed random variable distribution of SGD/Noisy-SGD outputs in the fine-tuning process, the latest results are used in

$${Δ}_{n , 1 , X} ( x ) \leq \frac{1.95 {K}_{4 , n} + 0.038 {λ}_{3 , n}^{2}}{n} + 𝒪 ( {n}^{- 5 / 4} ) .$$

The privacy budget ϵ is then computed via the inverse of δ(∈)=1−G_{n,1,Y}(∈)−Δ_{n,1,Y}−e^{∈}(1−G_{n,1,X}(∈)+Δ_{n,1,X}(∈)).

### Experimental Methods

The system and method described above is a general framework that can be applied to enhance the privacy of any LLM during fine-tuning. To assess the system and method, focus was placed on one of the most highly-adopted masked language models in AI tasks—roBERTa—which is popular due to its ability to learn bidirectional representations of a sentence. Such high-quality representations contribute to breakthrough results in common downstream natural language understanding (NLU) tasks, such as sentiment analysis and text categorization.

Moreover, to show the generalizability of the system and method, utility and privacy guarantees were tested across four important and complex NLU tasks (each included in the General Language Understanding Evaluation, or GLUE, benchmark dataset [29]) with each task being associated with a well-established dataset.

These datasets include the following: the Multi-Genre Natural Language Inference (MNLI), a collection of 433,000 sentence pairs that are annotated with semantic entailment information, with a LLM task to identify the semantic relationships between a given pair of sentences (entailment, contradiction, or neutral relationship) [30]; the Question-answering Natural Language Inference (QNLI), a natural language inference dataset that includes 110,400 question-paragraph pairs, where only one of the sentences in the paragraph is the answer to the corresponding question, with a LLM task to determine whether a sentence includes the answer to a given question [29]; the Quora Question Pairs (QQP) dataset, including over 400,000 question pairs that are each annotated to indicate whether the questions are semantic equivalents, with a LLM task to determine whether either of the questions is the paraphrase of the other [29]; and the Stanford Sentiment Treebank (SST-2) that includes 68,800 sentences from movie reviews and annotations of their sentiment, with a LLM task to predict the sentiment (positive or negative) of a given sentence.

The system and method were implemented on a roBERTa.base pretrained model having 125 million parameters. The train and test partition for each dataset was set as follows: for MNLI, 393,000 for training and 20,000 for testing; for QNLI, 105,000 for training and 5,400 for testing; for QQP, 364,000 for training and 391,000 for testing; and for SST-2, 67,000 for training and 1,800 for testing. To facilitate comparisons between datasets, the privacy parameters were set as follows: ∈=8, δ=1e−6 for the larger datasets (i.e., MNLI, QNLI, and QQP, since each includes hundreds of thousands of samples), and ∈=8, δ=1e−5 for the smaller dataset (i.e., SST-2, which includes tens of thousands of samples).

Performance was evaluated against two widely used state-of-the-art DP alternatives: Renyi Differential Privacy (RDP) [12, 21] and Privacy Loss Random Variables (PRV) [25]. Two sets of experiments were performed, including Experiment 1 to evaluate the accuracy of the LLM in solving the four NLU tasks noted above (MNLI, QNLI, QQP, and SST-2) after fine-tuning with the system and method described above, with RDP, and with PRV; and including Experiment 2 to evaluate the amount of noise introduced by the system and method compared to alternative privacy analysis agents for different values of E.

### Experimental Results—Experiment 1

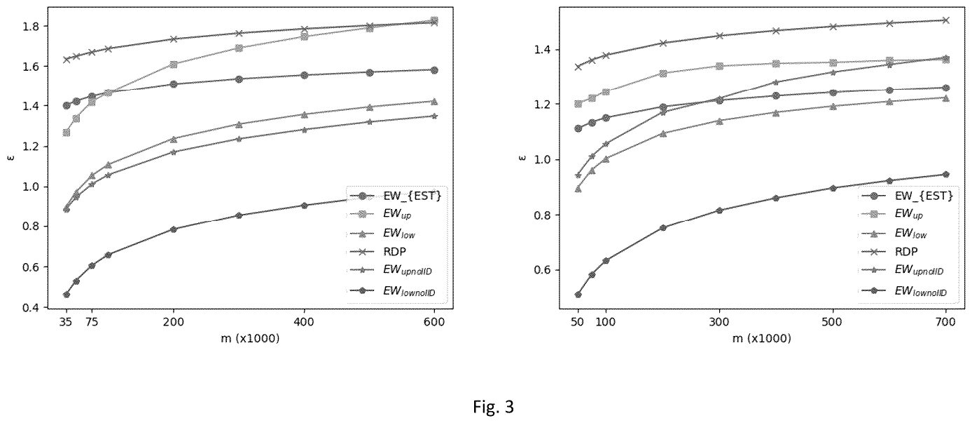

As shown in FIG. 3 (and Table 1 below), which shows the changes of E with the number of SGD invocations for 6=0.001 (on the left side of FIG. 3) and for 6=0.005 (on the right side of FIG. 3), the system and method were compared to RDP [34]. As noted on each graph, the upper bound and lower bound both bound the estimated performance under the system and method. As shown on the right side of FIG. 3 in particular, the privacy analysis agent produces inaccurate bounds (i.e., outside of the estimate upper bound and the lower bound) for 8=0.001 and 8=0.005.

TABLE 1
Privacy budget comparisons.

| δ = 0.001 | | | δ = 0.005 | | |
|---|---|---|---|---|---|
| m(*1000) | ϵ_{RDP} | ϵₒᵤᵣₛ | m(*1000) | ϵ_{RDP} | ϵₒᵤᵣₛ |
| 10 | 1.58 | 0.63 | 50 | 1.33 | 0.89 |
| 15 | 1.60 | 0.72 | 75 | 1.36 | 0.96 |
| 20 | 1.62 | 0.77 | 100 | 1.38 | 1.00 |
| 25 | 1.63 | 0.82 | 200 | 1.42 | 1.09 |
| 35 | 1.64 | 0.89 | 300 | 1.45 | 1.13 |
| 50 | 1.65 | 0.97 | 400 | 1.47 | 1.16 |
| 75 | 1.66 | 1.04 | 500 | 1.48 | 1.19 |
| 100 | 1.69 | 1.11 | 600 | 1.49 | 1.20 |
| 200 | 1.73 | 1.23 | 700 | 1.50 | 1.22 |
| 300 | 1.76 | 1.31 | | | |
| 400 | 1.78 | 1.36 | | | |
| 500 | 1.80 | 1.40 | | | |
| 600 | 1.81 | 1.42 | | | |

Gaussian Relaxation (GR) assumes that both Xᵢ and Yᵢ accept normal distributions to assess whether upper and lower bounds are valid (i.e., there is an expectation that any generic upper bound and any generic lower bound encloses GR). As shown in FIG. 3, the upper bound and the lower bound enclose the estimate for the system and method; however, the privacy analysis agent alone produces inaccurate bounds (i.e., outside of the estimate upper bound and the lower bound) for δ=0.001 and δ=0.005.

### Experimental Results—Experiment 2

As shown in Table 2, the results of the system and method were compared against RDP across four NLU datasets (MNLI, QNLI, QQP, and SST-2) as analyzed by the roBERTa LLM, specifically with respect to the epsilon value and accuracy. To report the performance, each experiment was repeated in triplicate and the average was reported.

TABLE 2
Comparison of model accuracy across multiple text and image datasets

| | Private | | | Non-Private |
|---|---|---|---|---|
| Dataset | ϵ_{RDP} | ϵₒᵤᵣₛ | Accuracy (%) | Accuracy (%) |
| MNLI | 1.65 | 1.15 | 80.66 | 83.08 |
| QNLI | 1.60 | 1.0 | 87.03 | 87.27 |
| QQP | 1.65 | 1.1 | 84.40 | 85.50 |
| SST-2 | 1.60 | 0.85 | 92.30 | 93.19 |

The best (i.e., the lowest value) privacy budget ∈ in each task was associated with the system and method. In addition, as seen in Table 2, the system and method yield an accuracy of 80.66% on the MNLI dataset, 87.03% on the QNLI dataset, 84.40% on the QQP dataset, and 92.30% on the SST-2 dataset. As such, the system and method produce highly accurate results while utilizing a privacy budget that is less than half of that of RDP; said another way, the system and method achieve high accuracy values and high privacy values while maintaining low computational resource requirements. The performance of the system and method is attributed in part to the utilization of the privacy analysis agent using the ƒ-DP privacy computation method (instead of CLT), thereby enjoying a better convergence rate with lower privacy budget, thereby applying less noise to the transformer layers of LLMs during training. Table 1 also shows the non-private accuracy, which reports the performance without the use of a privacy-preserving mechanism, thereby representing the accuracy without the introduction of noise. As shown in Table 2, the system and method achieve high privacy while reducing accuracy performance by only 2.42% on MNLI, 0.24% on QNLI, 1.10% on QQP, and 1.11% on SST-2.

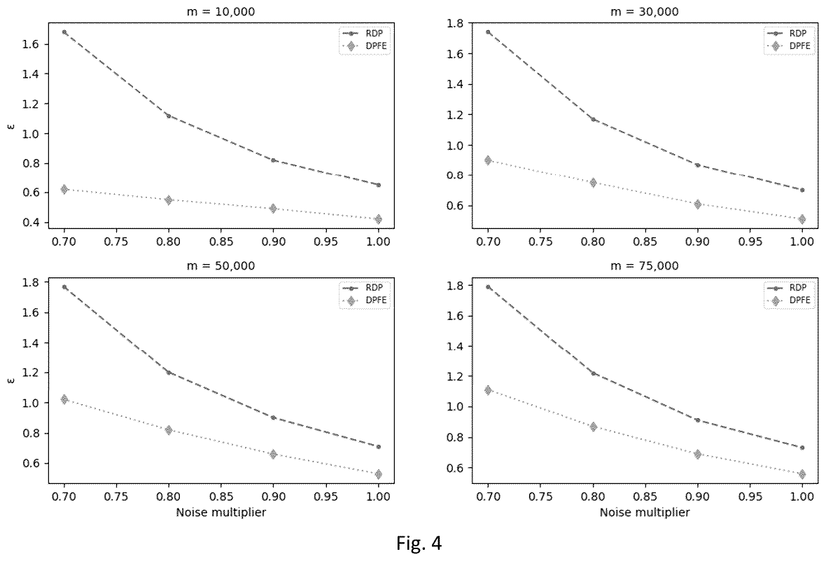

Turning to FIG. 4 (and Table 3 below), the effect of the noise multiplier on the privacy cost ∈ is analyzed as m (the number of iterations) increases from 10,000 to 75,000. The horizontal axis denotes the noise multiplier (the standard deviation of a zero-centered Gaussian noise). For all values of the noise multiplier, the privacy cost ∈ from the system and method is lower than that of RDP across all values of m. In addition, for smaller values of m, the gap in E between the system and method and RDP is larger.

TABLE 3
Comparisons of privacy budgets over different noise multipliers.

| m = 10,000 | | m = 30,000 | |
|---|---|---|---|
| ϵ_{RDP} | 1.68, 1.12, 0.82, 0.65 | ϵ_{RDP} | 1.74, 1.17, 0.87, 0.70 |
| ϵₒᵤᵣₛ | 0.62, 0.55, 0.49, 0.42 | ϵₒᵤᵣₛ | 0.90, 0.75, 0.61, 0.51 |
| m = 50,000 | | m = 75,000 | |
| ϵ_{RDP} | 1.77, 1.20, 0.90, 0.71 | ϵ_{RDP} | 1.79, 1.22, 0.91, 0.73 |
| ϵₒᵤᵣₛ | 1.02, 0.82, 0.66, 0.53 | ϵₒᵤᵣₛ | 1.11, 0.87, 0.69, 0.56 |

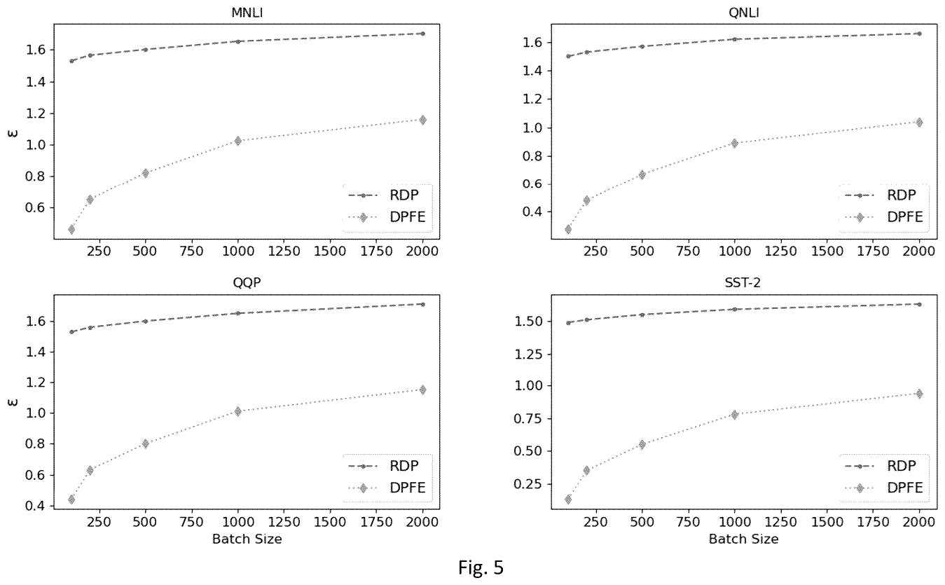

Referring now to FIG. 5 (and Table 4 below), the privacy cost in privacy preserving methods can be sensitive to the batch size parameter. Tests were performed on five common batch sizes (50; 100; 500; 1,000; and 2,000) to evaluate sensitivity to the batch size for the four text benchmark datasets (MNLI, QNLI, QQP, and SST-2). As shown in FIG. 5, as the batch size increases from 50 to 2,000, the system and method yield lower privacy costs than the RDP counterpart across all four text datasets.

TABLE 4
Comparisons of privacy budgets across different datasets.

| MNLI | | QNLI | |
|---|---|---|---|
| ϵ_{RDP} | 1.53, 1.57, 1.60, 1.65, 1.70 | ϵ_{RDP} | 1.50, 1.53, 1.57, 1.62, 1.66 |
| ϵₒᵤᵣₛ | 0.46, 0.65, 0.82, 1.03, 1.16 | ϵₒᵤᵣₛ | 0.28, 0.48, 0.67, 0.89, 1.04 |
| QQP | | SST-2 | |
| ϵ_{RDP} | 1.53, 1.56, 1.60, 1.65, 1.71 | ϵ_{RDP} | 1.49, 1.51, 1.55, 1.59, 1.63 |
| ϵₒᵤᵣₛ | 0.44, 0.63, 0.80, 1.01, 1.15 | ϵₒᵤᵣₛ | 0.13, 0.35, 0.55, 0.78, 0.94 |

### CONCLUSION

The system and method described herein is used to fine-tune LLMs. Utilizing a state-of-the-art privacy analysis agent and gradient perturbation methods, the system and method provides finite-sample privacy guarantees by introducing less noise compared to existing methods. Specifically, the system and method introduce up to 6% less noise when privately training LLMs, contributing to up to 1.1% improvement in performance, thereby addressing the gaps in privacy and accuracy tradeoffs in the realm of data privacy and AI. In particular, the system and method enhance performance by applying less noise to the SGD process, while achieving the same (or lower) privacy budgets as counterpart systems and methods. As such, the system and method outperform other privacy analysis agent-based systems and methods across different values of privacy budgets.

### REFERENCES

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.
[1]J. Devlin, M.-W. Chang, K. Lee, and K. Toutanova, “Bert: Pre-training of deep bidirectional transformers for language understanding,” arXiv preprint arXiv:1810.04805, 2018.
[2]D. Ham, J.-G. Lee, Y. Jang, and K.-E. Kim, “End-to-end neural pipeline for goal-oriented dialogue systems using gpt-2,” in Proceedings of the 58th Annual Meeting of the Association for Computational Linguistics, 2020, pp. 583-592.
[3]L. Fang, T. Zeng, C. Liu, L. Bo, W. Dong, and C. Chen, “Transformer-based conditional variational autoencoder for controllable story generation,” arXiv preprint arXiv:2101.00828, 2021.
[4]T. Brown, B. Mann, N. Ryder, M. Subbiah, J. D. Kaplan, P. Dhariwal, A. Neelakantan, P. Shyam, G. Sastry, A. Askell et al., “Language models are few-shot learners,” Advances in neural information processing systems, vol. 33, pp. 1877-1901, 2020.
[5]A. Radford, J. Wu, R. Child, D. Luan, D. Amodei, I. Sutskever et al., “Language models are unsupervised multitask learners,” OpenAI blog, vol. 1, no. 8, p. 9, 2019.
[6]J. L. Hu, M. Ebrahimi, and H. Chen, “Single-shot black-box adversarial attacks against malware detectors: A causal language model approach,” in 2021 IEEE International Conference on Intelligence and Security Informatics (ISI). IEEE, 2021, pp. 1-6.
[7]A. Ramesh, M. Pavlov, G. Goh, S. Gray, C. Voss, A. Radford, M. Chen, and I. Sutskever, “Zero-shot text-to-image generation,” in International Conference on Machine Learning. PMLR, 2021, pp. 8821-8831.
[8]N. Carlini, F. Tramer, E. Wallace, M. Jagielski, A. Herbert-Voss, K. Lee, A. Roberts, T. B. Brown, D. Song, U. Erlingsson, A. Oprea, and C. Raffel, “Extracting training data from large language models,” in 30th USENIX Security Symposium, USENIX Security 2021, Aug. 11-13, 2021, M. Bailey and R. Greenstadt, Eds. USENIX Association, 2021, pp. 2633-2650.
[9]N. Carlini, C. Liu, U. Erlingsson, J. Kos, and D. Song, “The secret sharer: Evaluating and testing unintended memorization in neural networks,” in 28th USENIX Security Symposium (USENIX Security 19), 2019, pp. 267-284.
[10]S. Hisamoto, M. Post, and K. Duh, “Membership inference attacks on sequence-to-sequence models: Is my data in your machine translation system?” Transactions of the Association for Computational Linguistics, vol. 8, pp. 49-63, 2020.
[11]M. Fredrikson, S. Jha, and T. Ristenpart, “Model inversion attacks that exploit confidence information and basic countermeasures,” in Proceedings of the 22nd ACM SIGSAC conference on computer and communications security, 2015, pp. 1322-1333.
[12]M. Abadi, A. Chu, I. J. Goodfellow, H. B. McMahan, I. Mironov, K. Talwar, and L. Zhang, “Deep learning with differential privacy,” in Proceedings of the 2016 ACM SIGSAC Conference on Computer and Communications Security, Vienna, Austria, Oct. 24-28, 2016, E. R. Weippl, S. Katzenbeisser, C. Kruegel, A. C. Myers, and S. Halevi, Eds. ACM, 2016, pp. 308-318.
[13]D. Yu, S. Naik, A. Backurs, S. Gopi, H. A. Inan, G. Kamath, J. Kulkarni, Y. T. Lee, A. Manoel, L. Wutschitz et al., “Differentially private finetuning of language models,” arXiv preprint arXiv:2110.06500, 2021.
[14]H. Wang, S. Gao, H. Zhang, M. Shen, and W. J. Su, “Analytical composition of differential privacy via the edgeworth accountant,” arXiv preprint arXiv:2206.04236, 2022.
[15]D. Yu, H. Zhang, W. Chen, J. Yin, and T.-Y. Liu, “Large scale private learning via low-rank reparametrization,” in International Conference on Machine Learning. PMLR, 2021, pp. 12 208-12 218.
[16]Y. Liu, M. Ott, N. Goyal, J. Du, M. Joshi, D. Chen, O. Levy, M. Lewis, L. Zettlemoyer, and V. Stoyanov, “Roberta: A robustly optimized bert pretraining approach,” arXiv preprint arXiv:1907.11692, 2019.
[17]A. Baevski, Y. Zhou, A. Mohamed, and M. Auli, “wav2vec 2.0: A framework for self-supervised learning of speech representations,” Advances in Neural Information Processing Systems, vol. 33, pp. 12 449-12 460, 2020.
[18]C. Raffel, N. Shazeer, A. Roberts, K. Lee, S. Narang, M. Matena, Y. Zhou, W. Li, P. J. Liu et al., “Exploring the limits of transfer learning with a unified text-to-text transformer.” J. Mach. Learn. Res., vol. 21, no. 140, pp. 1-67, 2020.
[19]Z. Yang, Z. Dai, Y. Yang, J. Carbonell, R. R. Salakhutdinov, and Q. V. Le, “Xlnet: Generalized autoregressive pretraining for language understanding,” Advances in neural information processing systems, vol. 32, 2019.
[20]C. Dwork, F. McSherry, K. Nissim, and A. D. Smith, “Calibrating noise to sensitivity in private data analysis,” in Theory of Cryptography, Third Theory of Cryptography Conference, T C C 2006, New York, NY, USA, Mar. 4-7, 2006, Proceedings, ser. Lecture Notes in Computer Science, S. Halevi and T. Rabin, Eds., vol. 3876. Springer, 2006, pp. 265-284.
[21]I. Mironov, “Renyi differential privacy,” CoRR, vol. abs/1702.07476, 2017. [Online]. Available: http://arxiv.org/abs/1702.07476.
[22]Z. Bu, J. Dong, Q. Long, and W. J. Su, “Deep learning with gaussian differential privacy,” CoRR, vol. abs/1911.11607, 2019. [Online]. Available: http://arxiv.org/abs/1911.11607.
[23]J. Dong, A. Roth, and W. J. Su, “Gaussian differential privacy,” CoRR, vol. abs/1905.02383, 2019. [Online]. Available: http://arxiv.org/abs/1905.02383.
[24]P. Kairouz, S. Oh, and P. Viswanath, “The composition theorem for differential privacy,” in International conference on machine learning. PMLR, 2015, pp. 1376-1385.
[25]S. Gopi, Y. T. Lee, and L. Wutschitz, “Numerical composition of differential privacy,” in Advances in Neural Information Processing Systems 34: Annual Conference on Neural Information Processing Systems 2021, NeurIPS 2021, Dec. 6-14, 2021, virtual, M. Ranzato, A. Beygelzimer, Y. N. Dauphin, P. Liang, and J. W. Vaughan, Eds., 2021, pp. 11631-11642.
[26]C. Dwork and G. N. Rothblum, “Concentrated differential privacy,” CoRR, vol. abs/1603.01887, 2016. [Online]. Available: http://arxiv.org/abs/1603.01887.
[27]S. Meiser and E. Mohammadi, “Tight on budget?: Tight bounds for r-fold approximate differential privacy,” in Proceedings of the 2018 ACM SIGSAC Conference on Computer and Communications Security, C C S 2018, Toronto, ON, Canada, Oct. 15-19, 2018, D. Lie, M. Mannan, M. Backes, and X. Wang, Eds. ACM, 2018, pp. 247-264.
[28]A. Koskela, J. Jalko, and A. Honkela, “Computing tight differential privacy guarantees using FFT,” in The 23rd International Conference on Artificial Intelligence and Statistics, AISTATS 2020, 26-28 Aug. 2020, Online [Palermo, Sicily, Italy], ser. Proceedings of Machine Learning Research, S. Chiappa and R. Calandra, Eds., vol. 108. PMLR, 2020, pp. 2560-2569.
[29]A. Wang, A. Singh, J. Michael, F. Hill, O. Levy, and S. R. Bowman, “GLUE: A multi-task benchmark and analysis platform for natural language understanding,” in International Conference on Learning Representations, 2019.
[30]A. Williams, N. Nangia, and S. R. Bowman, “A broad-coverage challenge corpus for sentence understanding through inference,” arXiv preprint arXiv:1704.05426, 2018.
[31]R. Socher, A. Perelygin, J. Wu, J. Chuang, C. D. Manning, A. Y. Ng, and C. Potts, “Recursive deep models for semantic compositionality over a sentiment treebank,” in Proceedings of the 2013 conference on empirical methods in natural language processing, 2013, pp. 1631-1642.
[32]Q. Zheng, J. Dong, Q. Long, and W. Su, “Sharp composition bounds for gaussian differential privacy via edgeworth expansion,” in International Conference on Machine Learning. PMLR, 2020, pp. 11 420-11 435.
[33]A. Derumigny, L. Girard, and Y. Guyonvarch, “Explicit non-asymptotic bounds for the distance to the first-order edgeworth expansion,” arXiv preprint arXiv:2101.05780, 2021.
[34]I. Mironov, K. Talwar, and L. Zhang, “Renyi differential privacy of the sampled gaussian mechanism,” arXiv preprint arXiv:1908.10530, 2019.

### Hardware and Software Infrastructure Examples

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device. Storage and services may be on premises or remote such as in the “cloud” through vendors operating under the brands, MICROSOFT AZURE, AMAZON WEB SERVICES, RACKSPACE, and KAMATERA.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A method of fine-tuning a large language model, the method comprising the steps of:
pretraining a large language model using a non-private dataset to generate a pretrained output;
inputting the pretrained output into a fine-tuning model; and
fine-tuning the pretrained output using a private dataset to generate a differentially private large language model by:
determining a set of privacy parameters including a privacy budget and a failure probability;
calculating, via a privacy analysis agent, a desired amount of privacy based on the privacy budget;
calculating, via the privacy analysis agent, a noise multiplier based on the desired amount of privacy to satisfy the privacy budget;
transforming the pretrained output using the noise multiplier to add an amount of noise to the pretrained output by clipping gradients of the pretrained output, aggregating the clipped gradients, and adding the amount of noise to the clipped gradients; and
fine-tuning, via a randomized differentially private stochastic gradient descent model, the transformed pretrained output by reparametrizing a weight matrix associated with each layer of the transformed pretrained output.

2. The method of claim 1, wherein the privacy budget and the failure probability are predetermined inputs into the differentially private large language model.

3. The method of claim 1, further comprising the step of defining, via the privacy analysis agent, a plurality random privacy-loss log-likelihood ratios.

4. The method of claim 3, further comprising the step of approximating, via the privacy analysis agent and for each of the plurality of random privacy-loss log-likelihood ratios, a cumulative distribution function.

5. The method of claim 4, further comprising the step of calculating a plurality of privacy budget guarantees based on the plurality of random privacy-loss log-likelihood ratios.

6. The method of claim 1, further comprising the step of computing, via the privacy analysis agent, a number of applications of the randomized differentially private stochastic gradient descent model to satisfy the privacy budget.

7. The method of claim 1, further comprising the step of fine-tuning, using the private dataset, each of a plurality of transformer layers of the transformed pretrained output.

8. The method of claim 1, wherein the randomized differentially private stochastic gradient descent model is derived from a reparametrized gradient perturbation.

9. A differentially private system including a fine-tuned large language model, the system comprising:
a processor; and
a non-transitory computer-readable medium operably coupled to the processor, the computer-readable medium having computer-readable instructions stored thereon that, when executed by the processor, cause the differentially private system to fine-tune the large language model by executing instructions comprising:
pretraining a large language model using a non-private dataset to generate a pretrained output;
inputting the pretrained output into a fine-tuning model; and
fine-tuning the pretrained output using a private dataset to generate a differentially private large language model by:
determining a set of privacy parameters including a privacy budget and a failure probability;
calculating, via a privacy analysis agent, a desired amount of privacy based on the privacy budget;
calculating, via the privacy analysis agent, a noise multiplier based on the desired amount of privacy to satisfy the privacy budget;
transforming the pretrained output using the noise multiplier to add an amount of noise to the pretrained output by clipping gradients of the pretrained output, aggregating the clipped gradients, and adding the amount of noise to the clipped gradients; and
fine-tuning, via a randomized differentially private stochastic gradient descent model, the transformed pretrained output by reparametrizing a weight matrix associated with each layer of the transformed pretrained output.

10. The system of claim 9, wherein the privacy budget and the failure probability are predetermined inputs into the differentially private large language model.

11. The system of claim 9, wherein the instructions further comprise defining, via the privacy analysis agent, a plurality random privacy-loss log-likelihood ratios.

12. The system of claim 11, wherein the instructions further comprise approximating, via the privacy analysis agent and for each of the plurality of random privacy-loss log-likelihood ratios, a cumulative distribution function.

13. The system of claim 12, wherein the instructions further comprise calculating a plurality of privacy budget guarantees based on the plurality of random privacy-loss log-likelihood ratios.

14. The system of claim 9, wherein the instructions further comprise computing, via the privacy analysis agent, a number of applications of the randomized differentially private stochastic gradient descent model to satisfy the privacy budget.

15. The system of claim 9, wherein the instructions further comprise fine-tuning, using the private dataset, each of a plurality of transformer layers of the transformed pretrained output.
